(19) United States
(12) Patent Application Publication
(10) Pub. No.: US 2007/0259555 A1
(43) Pub. Date: Nov. 8, 2007

(54) Cord apparatus

(76) Inventor: Carl J. Conforti, Fall River, MA (US)

Correspondence Address: CARL J. CONFORTI, 30 RIVERVIEW ST, FALL RIVER, MA, 02724, US

(21) Appl. No.: 11/796,866

(22) Filed: Apr. 30, 2007

Related U.S. Application Data
(60) Provisional application No. 60/797,268, filed on May 3, 2006.

(51) Int. Cl. H01R 13/62

(52) U.S. Cl. 439/369

(57) ABSTRACT

An apparatus comprising an attaching member, a spring like resilient body configured to receive cord like, tubing and like elements and a portion to be grasped by a person. The apparatus further configured to organize and temporarily store cord like objects with a provision of strain relief. The apparatus comprising a first attaching member configured to be temporarily attached to a substantially rigid body, a resilient main body comprising an inner diameter and outer diameter forming a passage from the attaching end to the distal end to be grasped by a person. The apparatus free to move vertically and horizontally further having the ability to rotate when acted upon by an external force. The apparatus configured to wrap cords, tubing or like members within the resilient main body at a desired height vertically suspended from the fixed end. The apparatus can organize and manage a series of cords like elements and provide extended flexibility in movement as desired by the user.

### CROSS-REFERENCE TO RELATED ACTIONS

This application claims the benefits of U.S. Provisional Patent Application Ser. No. 60/797,268, filed May 3, 2006.

### FIELD OF THE INVENTION

The present invention relates to the organization of cords, cables and tubular shaped devices, more specifically to an apparatus for positioning, organizing and suspending cords, cables and tubular shaped devices used in consumer, medical and industrial applications.

### BACKGROUND OF THE INVENTION

Devices available on the market today can provide a means to store and organize cords and linear lengths of rope or wire like products. These devices typically require the segments of cord to be wrapped around a rigid or fixed body or within a container or chamber to provide safe and convenient storage for extensions or lengths of tubular shaped products. Other devices use clamping methods to rigidly fasten a cord like member to a fixed point or position.

The need for a cord or tube organizer that offers flexibility and positioning of cords is more apparent in the healthcare and consumer marketplace. Many patients, nurses and physicians are subject to receiving or administering drugs, intravenous and exposed to other medical related devices that utilize cords, tubes and cable like products. These products are typically dispensed from a package through a long tube that is somewhat flexible, passing through the tubular shaped member into a catheter or into a patient's vein somewhere on the patient's body. Due to the necessity of the drug administered, it is common for this type of process to occur for many hours, subjecting the patient to some discomfort and restricted mobility. It is also common to see more than one type of medication administered to a patient, requiring several tubes to be guided to different locations on the patient's body or from various sources or a dispensing apparatus.

Often it has been difficult to move a patient due to the interface of tubing, cords and like elements being separated from the various dispensing mechanisms and more problematic physicians and or surgeons have an inconvenience of causing discomfort to the patient, or even accidentally disconnecting the tubing, cords, or like elements from the patient's body with no strain relief present within a cord or connection, administered from the device to the patients body.

Wheel chairs, hospital beds and surgery tables have a fixed point or hook to wrap an intravenous cord, monitoring cables or tubes around a semi rigid body once attached to a patient's body. These points are typically a fixed location, more depending on the co-efficient of friction to enable the cord or tube to freely move at the point of contact. The cords or tubes are typically made of rubber and have a high coefficient of friction, which would cause discomfort once the patient is moved and the cord or tube is placed in tension at the fixed location on the patient's body. More frequently concerns of having cords or tubes attached to a patients' body in an operating room make it difficult for the surgeons to move the patient or perform surgery with minimum intervention of the obstacles of disorganized dangling cords or tubing.

Other industrial or consumer related applications that may require some strain relief or to minimize tension allowing movement from a main body or system device connected with a elongated tube or cord. These applications are more apparent in the use of suspending cords in automotive lighting or testing, or industrial applications including suspension of cords to keep from hanging into hazardous water conditions that may result in electrical shock or other hazardous environments. An application in electronics may be useful were the device may disconnect with movement and a need for strain relief or minimum tension is present. A simple one hand operation interface is also useful.

The organization of cords and tubing is primarily fixed in nature with no ability to offer strain relief, a vertical resilient means, and pendulous motion to prevent or minimize discomfort in medical applications.

Cord, tube like organizers can be beneficial in providing strain relief in both consumer and industrial applications including but not limited to the healthcare industry, diagnostics industry and automobile repair industry, where cords can pose a hazard when held in close proximity to moving objects, such as a motor and lighting electrical cord.

### SUMMARY OF THE INVENTION

In general, in an aspect, the invention provides an apparatus that is capable of organizing and suspending cord like members. The apparatus comprises a first attaching member, second spring like main body configured to retain a cord like member and further configured to provide a spring like, elastic strain relief within the main body of the apparatus when the cord like member is acted upon by an external force, and a third distal opposite end from the attaching member configured to be grasped by a person. Implementations of the invention may include one or more of the following features. The attaching member configured to be attached and released onto an object or semi rigid body, preferably with one hand and further configured to attach vertically suspended from the object or body. The first attaching member further configured to be of plastic, metal or potentially a combination of the two. The metal preferably to be of stainless steel for medical and industrial applications and the plastic to be of a nylon, styrene or olefin like resins for cost, design and performance reasons. These plastics have spring like properties that can further be configured as a single piece part design to provide elastic or flexible properties without having multiple components as found in an assembly. The cost of injection molded plastic parts may be considered to be less than machined or fabricated metal parts in volume. The use of dissimilar materials also may provide a benefit to wear and performance characteristics along with temperatures or environmental conditions. In some instances it may be preferable to use a material that is easy to sterilize, therefore stainless steel or other like grades of material may be preferred. The ease of use to attach and detach the fastening or attaching member is preferred to be of a one handed operation. Therefore clips or spring loaded mechanisms are preferred, the mechanism configured with a hook like body, a retaining clip and a coupler configured to the hook like attaching body component that would preferably rotate and pivot about the hook like body and the resilient spring like main body. Yet another object may offer an attaching member configured by forming one end of the apparatus body in a hook like shape, to provide a low cost, simplified design eliminating a need for secondary components or a multiple part assembly.

Another object of the present invention is to provide a means to organize cords in a vertically displaced spiral body having a resilient main body to secure cord like members in various positions or multiple cords within a desired location onto the apparatus. The spiral body comprising a series of spring like coils configured to hold and position cord like members within the said spiral body configuration. The spiral body may be configured as a straight wire, a sinusoidal wave, square wave like shape configuration were along the spiral a series of interrupts are formed to capture the cord like member within a specific area of the spiral spring like body for positioning the cord like member. The wire may also be configured with a rubber like material to aid in positioning the cord like member, where the cord is temporarily positioned allowing the spring like coil to move when there is tension applied to the cord like member.

An object of the present invention is to provide strain relief between the fixed opposite end of the cord like member typically a device or power source and to the opposite end such as a patient or like body. The strain relief configured between a first attaching member and spring like body further configured to be attached and detached to an object. The device further configured to rotate freely about the first attaching member, where the rotation is preferably about the vertical axis of the suspended apparatus or device where the spring like body provides a strain relief from the attaching member to the cord like member and displaces with a force applied to the spring like body or distal end of the attaching member, providing strain relief on the cord like member held by the apparatus. The distal end may be optionally configured by forming a loop like shape within the spring body to hold a cord or to be grasped by a person. The distal end can be formed within main apparatus body or a component attached thereto the body to be grasped by a person. The portion of the end can be color coded, made of plastic or other like materials that may be removable or configured to indicate the design characteristics of the apparatus. The indicator may designate specifications on design, load, and applications of use and size limitations for the apparatus in various industries. It may be desirable to have multiple colors for multiple indicators of use, or apply identification for the consumer's name or like information.

Another object of the present invention is to provide organization of cords, tubes and like members with an apparatus. The apparatus comprises a resilient like material, suspended from an attaching end and a distal end configured to be grasped by a person. The resilient body material configured to move longitudinal and spherical at the distal opposite end of the apparatus with a provision to temporarily hold cord like or tubular members. Firstly an end comprising a attaching member configured to rotate, preferably 360 degrees and optionally pivot to provide angular displacement at the distal opposite end by one method disclosed a ball and socket or other like free rotating fastener configured to the attaching member, where the attaching member is further configured to be easily attached, hooked and detached or unhooked onto a fixed or semi rigid body (i.e. support rail, wheel chair, movable hood structure) within the vicinity of a patient, device or system. The apparatus is further configured to suspend cord like members at an elevated height, and prevent such cord like members from laying on a floor and interfering with moving objects. Another object of the invention is to provide a means to organize cords and tubular members at various heights and locations for ease of positioning and extending mobility of patients and or systems minimizing tension on the catheters or IV's administered to patient's. The apparatus may be configured with an elastic, rubber or spring like material to prevent the cord like member from slipping when positioned within the apparatus.

The apparatus may also be added for various reasons, such as weight, capacity, and number of cords or specific use of the color coded apparatus (i.e. red, blue, green, yellow). The color code may indicate use, applications, or designate ownership. According to a first aspect of the present invention, the apparatus comprises:

a resilient member vertically displaced over a defined longitudinal length, having the capacity to receive a cord or tube like object within the resilient member at various positions and further comprising a attaching mean at one end to attach to a fixed point somewhere in space and the resilient member (i.e. spring, elastic, elastomeric material) having the capacity to freely move at the opposite end in a conical angular displacement to provide strain relief, improved mobility and reduced tension by allowing movement of the cord like members and minimizing effects of fixed or rigid positioning and holding devices.

According to the above first aspect of the present invention, the spring like member comprises of a rust inhibiting material, having a diameter preferably of approximately 1.00 “to approximately 5.00” with the capacity to hold a cord diameter preferably of approximately 0.090″ to 1.00″ and the capacity to secure a multiple of cords within the spring like member to allow patients', nurses and doctors to improve mobility during medical treatment and relieve undesirable tension on elongated elements, cords or tube like members placed on patient's body.

According to a second aspect of the present invention, the spring like member comprises of a series of vertically displaced coiled elements, preferably made of metal or plastic like material. The coiled spring like elements having a static length defined at no load and a loaded state length where the spring material constant defines the coil lengths determined by the wire diameter, material properties and size of the coils. The coiled elements can be further configured with an optional rubber like outer surface, or selectively coated to help position the cords of the tubular members in a fixed location within the spring apparatus body. Another aspect of the present invention is to provide a method to position cords like or tubular members on the apparatus for organization.

According to the above second aspect of the present invention, there is an alternative option to have a first coil spring like body inside a second coil spring like body to allow specific cord like tubular members to be guided to a desired location or segregated from other members within the apparatus. This further can help organize and shield power cords from the external spiral spring member on its own or with another shielding component such as an insulator material or like material used to insulate or reduce EMI (Electro Magnetic Interference) or RFI (Radio Frequency Interference) from electronic devices. Other aspects may be used to shield data cables that may be affected by a power device or other cable, cord like device held within the apparatus.

According to a third aspect of the present invention, the apparatus comprises a low cost spring apparatus, an attaching means at one end and a means to vertically suspend and collectively organize a multiple cords and tubular like members into one preferred area or region for improved accessibility and optimize conditions for patient's safety and comfort. A divider may also be beneficial within the apparatus for organization.

Applications may include, keeping cords organized during operating procedures, or in industrial applications or furthermore around moving elements such as test equipment in utilized in testing and analyzing vehicles, equipment or other industrial applications. Cord like members may be spun around the coil spring like body to hold a desired position, or simply fed through a opening at any desired height of the said apparatus. The apparatus provides a desirable method to temporarily attach and detach cord like members conveniently and securely with minimum effort.

The present invention relates to an apparatus configured to vertically suspend and organize cords like, tube like members further providing a solution to improve mobility of a patient or device. Strain relief is also provided by the apparatus reducing tension from the interface to the fixed device. One method described as a spring like member fixedly attached at one end and free to move at the opposite end vertically suspended with gravity bearing weight having a minimum load carrying capacity to support the nominal weight of the cables, tubes and cords supported within the apparatus. The apparatus can be formed of a single piece, or made of multiple parts for an assembly. The apparatus is configured to be resilient, having the capacity to store at least a cord like member and provide a means for strain relief between the system and object being diagnosed.

Embodiments of the invention may provide one or more of the following capabilities. Making the organization of tubes, cords and alike easy to store either a single or multiple units in a vertically displaced apparatus. Many cord, tube organizers are fixed or having a mechanical clamping means that may effect the performance of the cord or tube like member (i.e. liquid or gas dispensing from a source to a patient) and or make it difficult to assemble or disassemble having a latch or other fixed mechanism to securely fasten the apparatus. There is a need where a minimum area is a constraint for a horizontal apparatus or to displace the cords horizontally due to the mobility of the end use (i.e. diagnostic object, patient or like body) or supply source (i.e. system, power source or like object) location. In some instances there may be a need to collect cords, tubes and like objects within a confined area that would enable or increase mobility with a resilient vertical displacement apparatus and simplified attachment component. The need for a strain relief mechanism also can be a benefit to the source and or end use (i.e. patient, industrial machine or like object) where the resilient mechanism can offer increased mobility within a defined area and allow the cords to be selectively attached and detached with a minimum amount of effort. Some circumstances may require the apparatus to be fixed on one end but having the ability to freely move on the opposite end, where the spring like member can allow mobility in movement without affecting the source or attaching means that is commonly fixedly attached. Another feature of the proposed apparatus may include the attaching means to freely rotate 360 degrees, to pivotally rotate at angles up to approximately 60 degrees from a vertically displaces free distal end, where more free movement and less strain is an end result of this design improvement.

Different configurations of the proposed apparatus can effectively position cord like cord like members in a vertical suspended orientation where the resilient like mechanism can enable cords, tubes and alike to be coupled to the apparatus or temporarily fixed to a specific location of height within the body of the apparatus providing organization and minimize tension within the system. Other applications of the apparatus may apply being fixed or rotatable and even rotated at one end allowing the cord or cable to route through the inner diameter of the apparatus for safety concerns and to help reduce wear on the cable like members from exposure to moving parts during handling and transport.

The apparatus can be configured of plastic, rubber, metal or a combination thereof. The attaching means at the one end of the apparatus can be made from the same like materials of the apparatus itself or formed as an integral part or assembly component such as a clip, hook, hook and loop, adhesive, magnet or other type of fastening mechanisms or combinations of the same. The diameter can be configured to hold a single cord or tube and alike or multiples of the same, where the design and the spring memory is further configured to hold the pre-determined weight of the cords, tubes and alike to be organized (i.e. heavy cords, higher spring constant or increase spring tension). The spring material specification, size and shape and spring constant can aid to determine the load carrying capacity for cables and like members to be supported by the apparatus. Although length may be configured for various applications, a variety of selective lengths can be configured to adapt to applications of different use. If a need for a multiple cord organizer exists, the pre-determined length can be selected with the apparatus spiral main body weight in consideration, the cords and tube like mass weight to provide an optimal design. The spring constant of the selected materials should also be configured to have elasticity and not strain or yield the materials properties due to the maximum weight of the cords and or spring mass exceeding the modulus of elasticity of the apparatus materials properties. The spring body can be configured with various materials and wire diameters to hold various configurations of cords like members.

A spiral resilient mechanism, inside a second spiral resilient mechanism may allow the first to carry one style of cord, tube like member and the second to receive another style or configuration of a cord or tube like member. The two vertically dispensed mechanism, one within another, offers a means to support and segregate various cords of different diameters and furthermore the inner resilient mechanism may provide a means to retain or release the cord like member as a locking member or component when rotated. The two coupled together at one end and having different lengths offers the advantage of one securely holding cords, tubing's and alike and the other to channel inside the diameter a second set of more semi permanent members as desired by the user. The apparatus can also be configured to shield power cords, or shield data cables from RFI (Radio Frequency Interference) utilizing radio frequency shielding or EMI (Electro Magnetic Interference) for EMI shielding. It may be desirable to have an apparatus guide or shield data cables from power cables, or even shield the administering of drug related products from other matter.

Springs can be manufactured of many different materials including but not limited to steel, stainless steel, wire, plastic, resin materials, rubber and like other materials. Stainless steel and referring to one type of metal more specifically type 316 can be beneficial in medical and food processing applications. This type material and similar like materials can have material properties that provide improved corrosion resistance, high levels of purity for medical and industrial applications along with easy to clean characteristics. Springs are typically categorized as compression, extension and torsion springs. The spring design characteristics further include squared ends, loop ends, ground ends, full diameter loops, partial loops, closed ends and left or right wound. To calculate the working length of compression springs we can use the equation P=r×F, where P is the load, r is the rate inch lbs per inch, and F is deflection from free length. It may be useful to understand the load of extension springs where P=(r×F)+I.T., P being the load in lbs, r being the inch lbs per inch and F is the deflection from free length and I.T. is the initial tension load. One can calculate the static load and also further calculate the load and deflection for one or more devices that are attached to the spring apparatus. The rate which is the change in load per unit deflection may be recorded one method as follows; deflecting a spring to approximately twenty percent of available of available load P1 and spring length L1, now deflect spring not more than eighty percent and measure load P2 and spring length L2 and be certain no coils are touching other than closed ends (to calculate R=(P2−P1)/(L1−L2) lb. per inch). It may be more beneficial to design a spring cord organizer for specific application (i.e. such as medical 2-5 cord IV holder; or industrial cord light holder) where the specific weights of the cords, tubes or cables are known and can the wire material and size can be designed for optimum conditions (i.e. load, deflection, conductive, or number of cords rated for the apparatus). Weights or loads for spring tension can be found anywhere from fractions of a pound to hundreds of pounds and is usually determined by the wire diameter, material, size, shape of the spring. It is more beneficial to have a spring that has the capacity to temporarily hold a cord, tube or cable with minimum tension and spring rate in the range of 0-10 lb/in., but with larger diameters it would not be unforeseeable to have these spring rates found from 0-10+lbs/in. Conical shaped spiral springs are other geometric shapes to consider, were a specific application may require more surface area contact at the leading edge or free distal end to secure movement of the cords, tubes or cables and further include a end that has a feature to guide the cords, tubes or cables to a specific area or position. Strain relief, free movement, conical displacement, and the ability to move about a variety of different axis are all important features of the proposed invention.

Embodiments of the invention may provide cord organization, a temporary source for vertical cord displacement, a means to consolidate a series of cords, or tubes temporarily without fixedly attachment mechanisms, provide a vertical control height of positioning cords within a longitudinal plane that makes it convenient for the user and environment, provide an improved method to organize cords in a potentially harmful environment. Other aspects may include an apparatus that provides shielding, mobility, a method to separate and differentiate cords of different capacities and provide a safety apparatus in organizing cords and tube like members for systems and alike. These and other details of the invention, along with the invention itself, will become more fully understood after a review of the following figures, detailed description, and claims.

### BRIEF DESCRIPTION OF THE FIGURES

In the drawings, like references to the apparatus and its parts generally refer to the parts disclosed in the specification, and the drawings may not necessarily be drawn to scale and only emphasis is to illustrate the general principle of the disclosed invention.

FIG. 1 is a front view of one embodiment of a cord apparatus.

FIG. 2 is a partial front view of the same cord apparatus extended.

FIG. 3 is an exploded assembly of one type of cord apparatus assembly.

FIG. 4 is a partial front view of various cord apparatus spring formations.

FIG. 5 is a perspective view of a spring like member and cord like members.

FIG. 6 is front perspective view of an apparatus spring member and a divider.

FIG. 7 is top end view of an apparatus spring member and divider.

FIG. 8a is a perspective view of an apparatus automotive application.

FIG. 8b is a perspective view of an apparatus industrial application.

FIG. 9a is a perspective view of an apparatus shown in a medical application.

FIG. 9b is a perspective view of an apparatus shown in a medical application.

FIG. 9c is a perspective view of an apparatus shown in a medical application.

FIG. 10 is a front view of an apparatus illustrating strain relief and displacement

### DETAILED DESCRIPTION OF PREFERRED EMBODIMENTS

Embodiments of the invention provide various techniques for organizing and providing strain relief in cords, cables and tube like members. Cords and like members having substantial length can be supported with the proposed invention described as a cord apparatus. The apparatus comprises a main body, attaching member and free distal end to be grasped by a person. The main body comprising of a spring like material with resilient and flexible spring like properties having the capacity to hold a cord, tube or cable like product within or between adjacent spring members through a portion of the main body's overall length. The main body spring comprises of plastic, metal or composite materials there of having the ability to be resilient and flexible with the capacity to move freely when an external force is applied from the fixed attaching member to the free distal end portion to be grasped by a person. Applications that require improved mobility, organization and strain relief within a system due to external forces are considered in the detailed description and figures here in the specification. Other embodiments are within the scope and spirit of the invention as reflected in the appended claims.

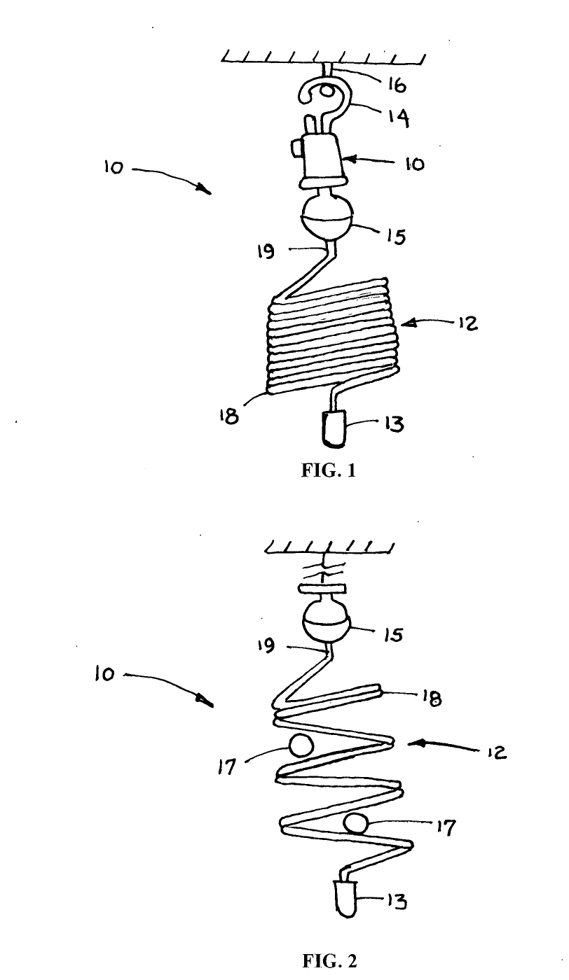

Referring to FIG. 1, a cord apparatus 10 configured with an attaching member 11, a main spring like body 12, and a portion to be grasped by a person 13. The attaching member 11, configured to be removable and attachable onto an object, preferably with a one hand operation, comprising a hook like element 14 and a rotatably, pivotably moveable member 15, attached to a resilient spring like body 12. The rotatably, pivotably moveable member 15, preferably rotates about 360 degrees and pivots about 30 degrees to a maximum angular distance of about 90 degrees enabling the body of the device to move within a conical spherical like pattern of free movement. Other configurations may be considered, such as the attaching member 11, having one hook like element with the ability to pivot and not rotate, or a hook like element 14, configured to be an integral part of the main spring like body 12, and the portion to be grasped by a person 13 to configured to be formed within the main spring like body 12, at one end.

The cord apparatus 10, configured with a resilient body 12, configured to move both vertically and horizontally when an external force is applied to the spring like body 12, or through a cord or tubular shaped member contained within the spring like body 12. The attaching member 11, configured to be temporarily fastened to a substantially rigid body 16, vertically displaced at an elevated height to support cord like members allowing mobility and additionally providing strain relief within the apparatus assembly. The distal end comprising a portion to be grasped by a person 13, can be configured of plastic, metal or other like materials, or fabricated to provide a means for consumers to easily grasp the apparatus at one end. The portion to be grasped by a person 13 can be color coded, for defining characteristics of the apparatus, end user or application of use.

FIG. 2 further illustrates a partial front view of the apparatus 10, of FIG. 1 including a rotating pivoting movable member 15, where the movable member 15 can be configured as a hook, ball and socket assembly, hook and loop material or elastomer having the ability to freely move about the central axis from the vertically displaced spring like resilient body 12, which can be further defined as a spring like resilient material with a geometric shape configured to hold a cord like member 17, inside the resilient spring like body 12, or within a section of the spring like body 12, having the ability to move when an external force is applied to the cord like member 17, providing strain relief.

The spring like body 12, in one embodiment is formed in a configuration as a spiral spring comprising a series of loops 18, where the spring like body 12 has one end 19, aligned and connected to an attaching member 11, and an opposite distal end 13, configured to be grasped by a person. The spring like body 12 can further be configured where the material is flat or round wire of like material that can elongate moving vertically up and down when acted upon by an external force.

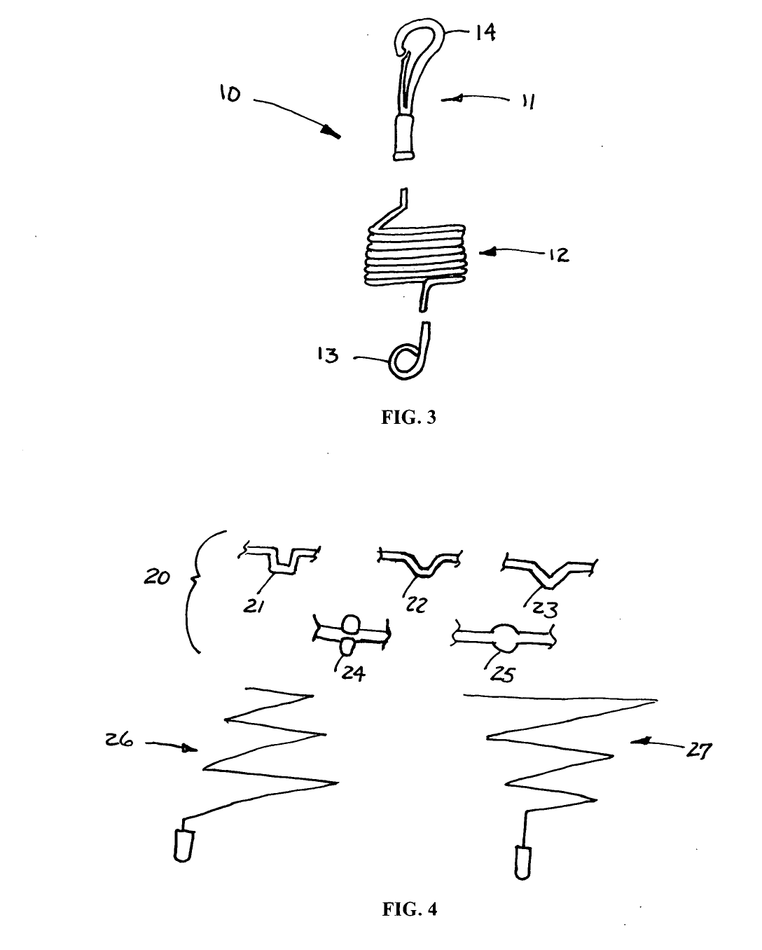

FIG. 3 presents an exploded assembly view of the components of an apparatus 10, having an attaching member 11, a hook like portion 14 to conveniently attach the apparatus to a second body preferably with a one handed operation, a resilient body 12, comprising of a spring like material to retain and provide strain relief to cords and like objects, and a portion to be grasped by a person 13, that can be configured as part of the resilient body 12, or an assembled component thereof. The portion to be grasped by a person 13, can be optionally color coded or configured to a shape, color or size to indicate the properties or physical capacity of the cord apparatus.

In FIG. 4, various material configurations, shapes and styles are illustrated for the spring body material. In preference to design, the various configurations of resilient spring materials can be formed 20, a square geometry form 21, may be more desirable to retain a cord like member 17, within the resilient body 12, to locate the cord like member 17, to a specific location.

Yet another round geometry form 22 may be desired to locate a cord like member 17, for the same reason and another “v” geometry form 23, having preference of any other disclosed geometries. Cost, materials and manufacturing processes may determine the most appropriate forms 20, for the desired application. In relation to a style of wire form, one protrusion style 25, may be formed within the resilient body 12, throughout the spiral body at a desired height, or applied as a secondary component protrusion 24, where the protrusion is movable or selectively placed within the resilient body 12. Yet another consideration for the resilient body 12 is to form a conical shape, or tapered spring like member, where in the tapered spring body 26, is configured wider at the base for ease of attaching cord like members, or a second optional style tapered spring body is formed wider at the top over a vertically displaced length for various applications limited to space or for cord like members to be vertically displaced apart from one another when positioned at various levels on the body or object. The spring like body 12, material can further comprise a series of styles, shapes or configurations to keep the cord like member(s) in a desired position. Another advantage of the various shaped spring like body formed depressions is to further organize the cord or tube like members in both the vertical and angled position for facilitating multiple cords or tubes and providing a directional positioning to and from the cord or tube like members opposing ends. The shapes 20 however can be manufactured to any shape or size to accommodate specific cord like diameters, styles or shapes for a specific application.

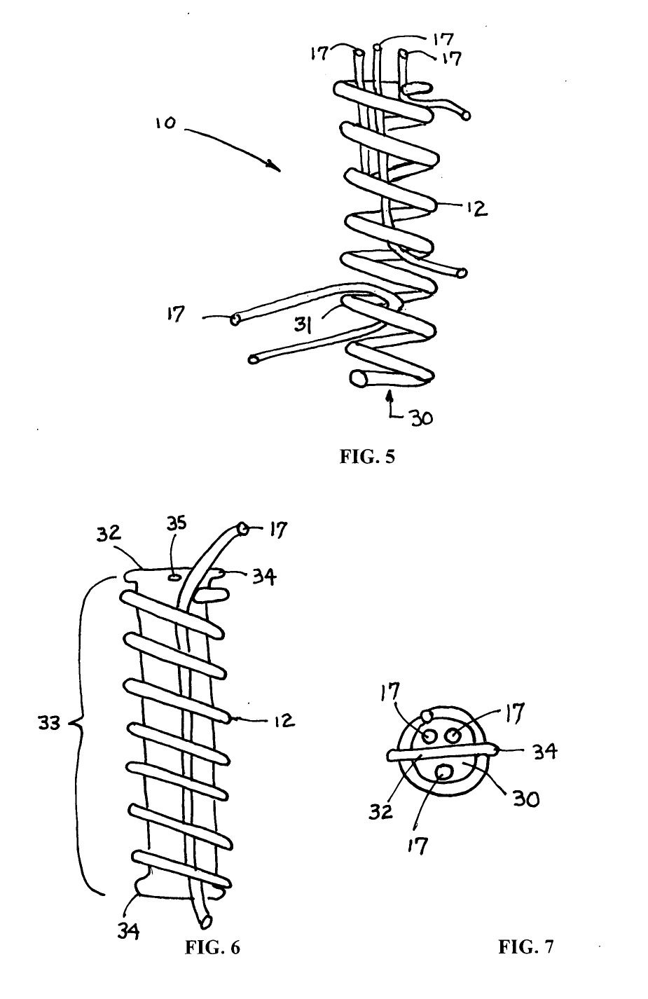

Referring to FIG. 5, the apparatus 10, and spring like resilient body 12 is configured to hold and organize various cord like members 17, and configured vertically position able where multiple cord like members are retained at a desired height. In one aspect of the invention the cord like members are fed through the inner diameter 30 of the resilient body 12, of the apparatus 10, where the spring like resilient body 12, protects the cord like member 17, from external forces, moving objects and wear. The cord like member 17 may be positioned to a specific height, or guided through the apparatus to directionally locate the cord like member 17 between the object and system or device. Another aspect of the present invention enables the user to wrap a cord like member 17 around an opening and spiral segment 31, of the resilient body 12, of the apparatus. Where cord like members can be easily retained with minimum effort and intervention.

Another embodiment of the present invention is to provide an extension spiral spring element, configured to hold a elongated cord, tube or cable, wherein the spiral spring element has a pre determined length and number of coils to wrap a cord, tube or cable around at least a portion of the spiral spring element coil, to secure the cord, tube or cable suspended at a height greater than that of the distal end of the apparatus or opposite end of the cord, tube and or cable that is attached to a patient for administering medical treatment. Yet another embodiment is to provide a strain relief, to the fixedly attach end that may have a need to move about a short distance within the perimeter of the cord apparatus. It is further a provision of the invention to provide a spiral coil that may be configured with a round wire, a spiral wire or a multiple component coil. The spiral coil configured within a spring like cord apparatus may also have a coating to aid in placing the cord like members 17, onto the apparatus 10, or even to aid in reducing friction to avoid unwanted tension from system to the interface.

Referring to FIG. 6, a main body 12, and a divider 32, held within the inner diameter 30, of the main body 12, the divider 32 having an overall length 33 of at least at least a portion of the length of the main body 12, the portion length that is desired to keep cord like products segregated and further configured to have at least a portion of one end 34, of the said divider larger than the inside diameter of the inner diameter 30 of the main body 12. The divider 32 can be selectively located and provide a segregated channel to organize and separate cord like members 17 from one another. The divider 32 may be configured flat or of a three dimensional shape (i.e. tube shape or channel). In some instances, more specifically with data transfer and power cables the divider 32, may be configured to provide RF radio frequency shielding or provide a channel to directionally locate cord like members 17 for systems and like machine interface.

Referring to FIG. 7, the divider 32 and the main body 12 is presented in a top end view where cord like members are separated in a channel configured by the divider 32 through a desired length of the main body 12. In some applications it may benefit the user to have an attaching means 35 located within the body of the divider 32 for attaching and detaching the main body 12 to a secondary component or rigid body. The divider 32 can be made of plastic, metal or other like materials or even a combination of two or more materials.

An embodiment of the present invention may be configured of a non conductive material, to prevent to the risk of shock or other electrical hazards. Furthermore, a material that is easy to sterilize, such as stainless wire, or plastic resins can provide benefits for using the apparatus in industrial or medical applications. Although the invention is not limited to the medical or industrial applications, other embodiments such as airplane repair, automotive diagnostic and test, light cord suspension or vertical cord organizers may prove beneficial for safety or occupational hazards, such as keeping electrical cords contained or out of moving mechanisms and parts. The invention can provide cords and like members in testing equipment cables vertically organized and away from hazards (i.e. moving parts, water) while working on a vehicle including but not limited to automobiles, marine and aircraft. Various applications may be evident in other areas from further review of the specification, figures and claims.

The apparatus may be color coded for indicating weight carry capacity, or specific application use along with various elements for economy series with a simple formed looped end attaching means, or a more complex assembly utilizing an attaching means with a spring mechanism, and a free distal end having the capacity to capture the cord, tube or cable with a formed loops of retaining clamp to secure and adjust a cable movement with features including longer lengths, or various diameters.

A series of semi circles affixed to a narrow spring like element supported by a single point forming a spinal cord like structure with the desired flexibility to move in various axis and allow thin tubular elements to be suspended and organized within the frame of the apparatus. The length of the apparatus can vary depending on the application and desired cord, tube or cable to be supported by the apparatus.

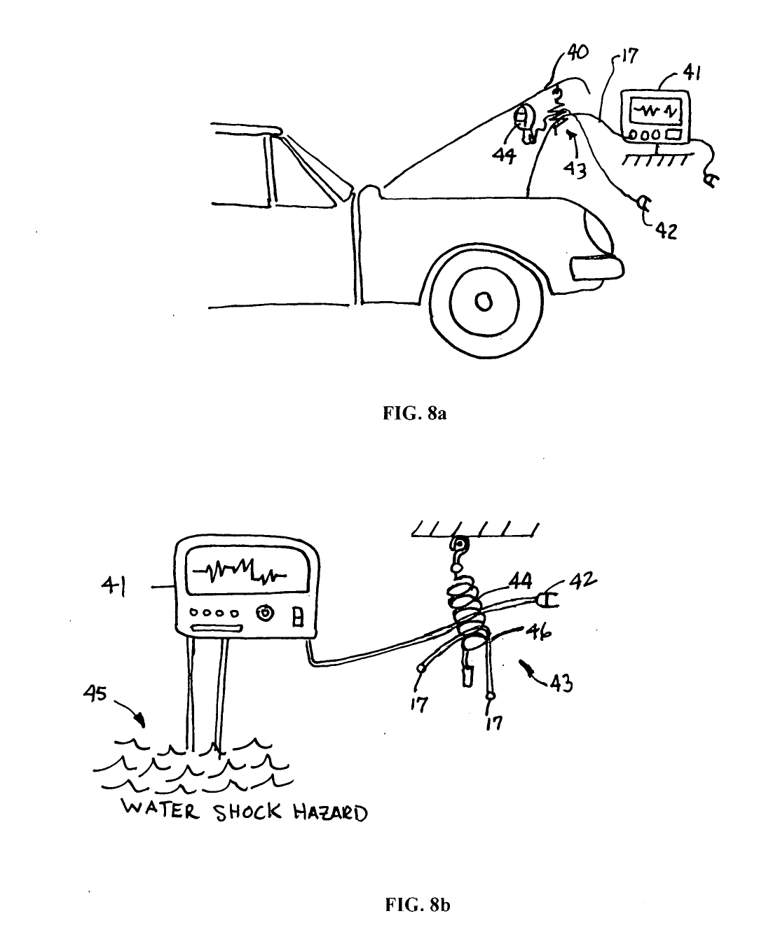

Referring to FIG. 8 a vehicle 40, a machine 41 and a light source 44, are connected by a cord like member 17, and a power source 42, where the cord like members 17, are subject to moving parts and heat within the area of the vehicle 40, and the cord like members 17 are suspended by an apparatus 43, supporting and organizing the cables, power cord and like members 17 from hazardous moving parts inside the vehicle. The apparatus 43 provides strain relief when an external force is applied to the cord like members 17, and vertically suspends and organizes them for safety and convenience. The apparatus is configured to move freely in two or more dimensional planes, having the ability to move somewhat freely vertically suspended and further having the ability to pivot when a force is applied and optionally rotate to keep the cordlike member suspended.

Referring to FIG. 8 b a machine 41 and hazardous water conditions 45 and cord like members 17 along with a power source 42, are supported by a apparatus 43, and the apparatus is vertically suspended to elevate the systems cord like members 17, and power cord 42 from hazardous water conditions 45. The cord like member 17 is wrapped around the apparatus 43, at a desired height 46. The lower portion of the apparatus 43 provides the most movement or strain relief, where the upper portion closest to the fixed end and attaching member provides the least amount of strain relief or movement securing the cord like members 17 and power source 42 from hazardous conditions or electrical shock. The cord like member 17 can be selectively place anywhere between the distal end and up to the attaching member, preferably at a desired height 44, or wrapped around a portion of the apparatus 46 at a desired height as illustrated in the drawing. The apparatus 43 again provides strain relief when an external force is applied to the cord like members 17, and vertically suspends and organizes them for safety and convenience.

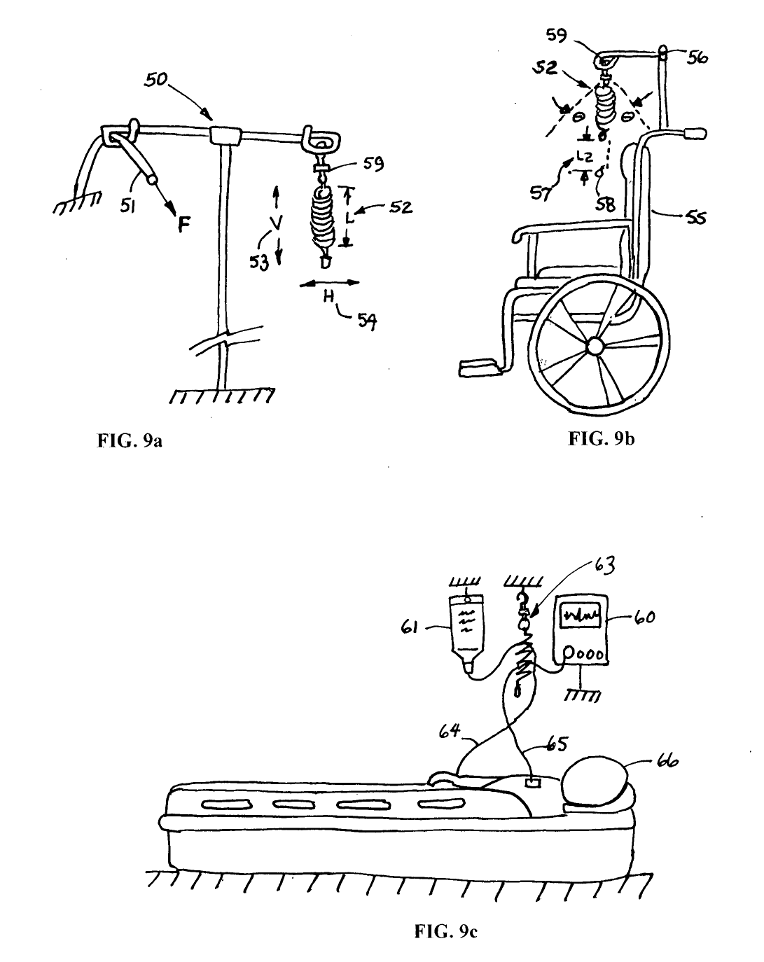

Referring to FIG. 9 a, a substantially rigid body 50, configured to hold a tube like member 51, where the tube like member 51 is rigidly connected on one end and subject to an external force on the opposite distal end. The cord apparatus 52, comprising of a vertically suspended spring like element having a defined length, further having the capacity to move horizontal 54 and vertically 53, and optionally rotate about a central axis of the attaching member 59 and apparatus 52 providing a strain relief and or ample movement to relieve tension on the patient of object where compared to the fixed, friction aided cordlike member 51 shown in the illustrative figure having no strain relief provision. The materials may be anti bacterial treated or preferably sterilized.

Referring to FIG. 9 b, a substantially rigid member 56 on a moving body 55 is further improved by an apparatus 52, suspended from the rigid member 56, attached to the moving body 55 (i.e. wheel chair or like vehicle). The apparatus 52, comprises a attaching member 59, a distal end 58, configured to be grasped by a person and having a spring like body that is configured to move at least a length 57 determined by the material, size and shape of the apparatus and desired anticipated load. The apparatus 52 further configured to move angular about the attaching member 59, and rigid member 56 providing ample flexibility or movement providing a strain relief for tube like members 51 and cord like members 17 within the apparatus. The apparatus 52 is configured to prevent cord like elements 17 and tube like members 51 from contacting or interfering with moving parts (i.e. such as wheel chair wheels, and like vehicle) and further provides patients a method to organize, drug intravenous, medical equipment and like diagnostic systems. Other features may include the patient having the ability to grasp the apparatus distal end and move an object or cords suspended inside the apparatus to a retainable distance within the patients reach.

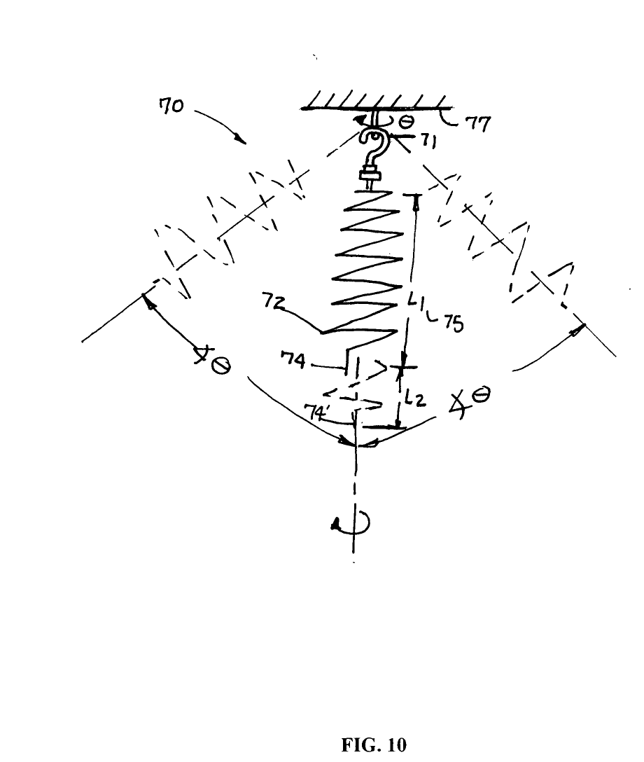

Referring to FIG. 9 c, a medical system 60, configured to monitor a patients well being, an intravenous support system 61, provided to care for a patient 66 were a patient 66 may require a catheter or IV tube 64 on the patient's body, and where catheter or IV tube 64 is configured like a tube like member 51, and is further configured with a length of tubing that may be presented to move the patient and reduce tension within the medical system or device. The length of tubing may come in contact with moving parts or become an inconvenience with the doctors or staff during patient care. An apparatus 64 can provide a method to organize, vertically suspend a catheter or IV tube 64, a diagnostic cord like member 65 to a patient 66 with minimum effect of external force applied to such members and multiple members can be organized with separate apparatus 63 or at various locations within the apparatus 63. The patient of caregiver may suspend cord like members and organize them in such a way to prevent cord like members from being placed in tension, or hooked inside a moving bed or rail and wheelchair moving parts. Referring to FIG. 10, an apparatus 70 comprises an attaching member 71, a spring resilient body 72 and a portion to be grasp by a person 74. The apparatus 70 is defined by a length 75, from the attaching member 71, to at least a portion to be grasped by a person 74. The apparatus is free to move both horizontally, where at the distal end having the most displacement and vertically expanding to allow temporary storage of cord like members 76, and further having an optional capability to freely rotate about the central axis defined by the attaching member 71 to s substantially rigid body 77, through the apparatus spring resilient body 72 and finally to the end portion to be grasped by a person 74. The apparatus 70 may be desired to be formed of a spring like wire where the cross section is of at least four to one ration or three to one (i.e. wire cross section 0.0625-0.877×0.0150-0.025) where the spring like body portion has resilient properties that will support a cord like member and displace when acted upon by an external force. Applications for the invention may become more apparent in view of the figures and drawings within the specification.

Features of various components of the disclosed invention may be interchanged among the components of the apparatus. For example an attaching method may be one of a clip fastener, hook and loop material and or a loop formed within the wire main spring resilient body. A divider may further be used in multiples to offer a division of two or more channels. Other embodiments are within the scope of the invention and the appended claims. For example, while many embodiments of the invention are preferably configured to be cord organizing elements, they may be configured to be reusable, disposable, indicators of tension beyond a pre-determined limitation.

What is claimed is:

1. An apparatus configured to organize cord like members, the apparatus comprising:
a first attaching member configured to be grasped by a person, vertically suspended and attach and detach the apparatus onto a substantially rigid body to an elevated height;
a second spring like resilient main body configured to have an attaching element at one end and further configured to be vertically displaced in space to provide strain relief to an object supported by the spring like resilient main body and first attaching member;
and a third opposite distal end, providing a portion of the said apparatus to be grasped by a person,
wherein the apparatus is configured with a spiral resilient spring like body, having the capacity to temporarily suspend, retain and organize cord like elements

2. The apparatus of claim 1 wherein the material is configured to be stainless steel.

3. The apparatus of claim 1 wherein the attaching member is a hook like clip.

4. The apparatus of claim 1 wherein the spring like resilient body is configured to both pivotally rotate and vertically displace about the attaching member.

5. The apparatus of claim 1 wherein the distal end to be grasped by a person is configured with a rubber like material.

6. The distal end to be grasped by a person of claim 4 wherein the material is further configured to be distinctively color coded.

7. The attaching member of claim 3 wherein the clip is a spring loaded.

8. A cord apparatus configured to vertically suspend and retain cord like members, the apparatus comprising:
a first attaching member configured to be grasped by a person, and attach and detach the cord apparatus onto an object at an elevated height;
a second main resilient body comprising an attaching member and configured to be attached and vertically displaced providing organization and strain relief of elongated elements;
and a third portion of the said apparatus to be grasped by a person, wherein the apparatus is configured to easily attach and detach with a resilient body, having the capacity to temporarily suspend, retain and organize cord like elements

9. The apparatus of claim 8 wherein the material is configured to be formed of one component.

10. The apparatus of claim 8 wherein the attaching member is a spring hook like clip member.

11. The apparatus of claim 8 wherein the resilient body is configured to both pivotally rotate and vertically displace about the attaching end.

12. The apparatus of claim 8 wherein is further configured with a divider to separate cordlike members.

13. The apparatus of claim 8 wherein the material is further configured to be RFI or EMI shielded.

14. An organizer configured to temporarily position and hold cords, and like tubing elements, comprising: a first main body having a vertically displaced passageway configured with a series of resilient spirals forming a vertically displaced length, the spiral formed spring like member having opposite ends and a first upper end comprising an attaching means and a second opposite and opposing end configured to move freely and configured to be grasped by a person;
wherein the spiral formed resilient main body is configured to move in a radial conical displacement around the central axis of the opposing fixed end, wherein the spiral formed spring like member comprises an exterior diameter and a second interior diameter configured to receive cords, tubing and alike, wherein the inner diameter is further configured to retain cords, tubing and like elements;
wherein the diameter of the interior spiral passageway, or the spiral body can conveniently suspend cords, tubing and like elements configured to provide strain relief to a patient or object.

15. The organizer of claim 14 wherein the coils are configured with spiral geometry configured to retain the cord, tube or like element.

16. The organizer of claim 14 wherein the spring like element is configured to be easily attached and detached to a fix body.

17. The organizer of claim 14 wherein is made on a non conductive material.

18. The organizer of claim 14 wherein the apparatus is free to rotate, elongate and move about a conical angular displacement of 0 to 60 degrees.

19. The organizer of claim 14 wherein the apparatus comprises a resilient member inside a second resilient member.
